(19) United States
(12) Patent Application Publication
(10) Pub. No.: US 2016/0376173 A1
(43) Pub. Date: Dec. 29, 2016

(54) ELECTROCHEMICAL CELL FOR WATER TREATMENT

(71) Applicant: AQUAHYDREX PTY LTD, North Wollongong, New South Wales (AU)

(72) Inventors: Gerhard Frederick SWIEGERS, Woonona (AU); Steven Duwayne KLOOS, Naperville, IL (US)

(21) Appl. No.: 15/103,042

(22) PCT Filed: Dec. 10, 2014
(86) PCT No.: PCT/AU2014/050409

§ 371 Date: Jun. 9, 2016

(30) Foreign Application Priority Data
Dec. 10, 2013 (AU) 2013904802
Dec. 10, 2013 (AU) 2013904803
Dec. 10, 2013 (AU) 2013904804
Dec. 10, 2013 (AU) 2013904806
Dec. 10, 2013 (AU) 2013904807
Dec. 11, 2013 (CA) 2836687

(51) Int. Cl. C02F 1/467; C02F 3/20

(52) U.S. Cl. CPC C02F 1/4674; C02F 1/4676; C02F 3/202; C02F 2001/46166

(57) ABSTRACT

An electrochemical cell for the treatment of water, the electrochemical cell able to generate, preferably on-site and/or in-situ, one or more chemicals for the treatment of water. Preferably, the electrochemical cell is a spiral-wound arrangement of one or more gas diffusion electrodes, for example a multi-electrode array. Preferably, the cell includes one or more gas diffusion electrodes that are permeable to a gas but impermeable to water.

### TECHNICAL FIELD

The present invention relates to electrochemical cells, modules or reactors useful in water treatment.

### BACKGROUND

Water treatment is an increasingly pressing issue in the modern world. As populations increase, new and improved methods are needed to purify water by eliminating unsafe contaminants like microorganisms and pollutant chemicals.

A range of new technologies have been developed to facilitate water treatment. These technologies and their applications are as many and as varied as the challenges that exist in the field of water treatment. To illustrate these challenges, one may consider several examples of recent new technologies in this field.

The company Silver Bullet Water Treatment Company, LLC, of the United States of America, has developed a modular unit with which to provide agricultural livestock with pure drinking water. Without clean water, animals like dairy cows, are subject to disease and low productivity. The technology involves the “drawing-in” and subsequent conversion of atmospheric oxygen using high-intensity UV light, into highly reactive oxygen species (oxygen radicals and hydrogen peroxide), which destroy bacterial growth in the water. They also keep calcium dissolved in solution, thereby preventing scaling in various drip systems and other parts of livestock drinking water systems. A similar approach, based on the formation of ozone using a UV reactor, has been developed by the company Ozonia, part of the Degrémont S.A. group, as a general biocide.

A second example is the company MIOX Corporation, of the United. States of America, which has developed a series of electrolytic cells that generate mixed oxidants, including sodium hypochlorite and hydrogen peroxide, for destroying biological microorganisms during water disinfection. Key applications include the air-conditioning cooling towers that are widely used in public buildings. If not maintained properly, such towers may come to harbour Legionella bacteria, which cause Legionnaires disease. Legionella bacteria are readily transmitted by air-conditioners, thereby posing a public health risk. Al the present time, cooling towers must be regularly treated using chemicals. Such treatment protocols are not only expensive, but also time- and personnel-intensive. Moreover, any errors or omissions in the treatment regimen create a potential public health risk with attendant public liability risks.

A third example is the company E3 Clean Technologies Inc., of the United States of America, which has developed proprietary electrochemical cells for converting urea and ammonia in water streams to nitrogen and hydrogen gas. The problem of urea and ammonia contamination derives from the widespread use of fertilizers in agriculture. When the fertilizers run off with, for example, rain, the water becomes contaminated and unsafe for human consumption. The E3 Clean Technologies Inc. technology is built around an electrolytic cell that carries out the above transformation. The gaseous nitrogen and hydrogen produced by the process of E3 Clean Technologies Inc. are easily removed from the stream of treated water and then either stored for sale (hydrogen) or allowed to safely enter the atmosphere (nitrogen).

A final example involves the company OpenCEL, LLC, of the United States of America, which has developed a “Focused Pulsed Technology” in which precisely controlled pulses of high voltage electricity are passed between two electrodes while biomass passes through. The treatment typically last less than 500 microseconds and breaks down the cell membranes of cells in the biomass, which thereby becomes permeable to small molecules and easier to treat.

In summary, as demonstrated by the examples above, there remains an ongoing need for new and alternative ways to treat water.

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

### SUMMARY

This Summary is provided to introduce a selection of concepts in a simplified form that are further described below in the Examples. This Summary is not intended to identify all of the key features or essential features of the claimed subject matter, nor is it intended to be used to limit the scope of the claimed subject matter.

In one aspect, there is provided an electrochemical cell for the treatment of water, comprising abiological components, and the electrochemical cell able to generate, on-site or in-situ, one or more chemicals for the treatment of water. Most preferably, the cell is spiral-wound, i.e. at least partially formed of one or more electrodes that a wound in a spiral fashion. Reference to treatment of water includes treatment for any use including potable uses and non-potable uses, such as for irrigation, toilet flushing, showering or bathing, cooling tower water, industrial process water, municipal wastewater, industrial wastewater, etc.

In one example, the electrochemical cell can enable on-site generation of one or more chemicals that are needed for water treatment, thereby minimizing or negating the need for delivering chemical to the site needed for water treatment. Additionally, in another example, the electrochemical cell can produce the water treatment chemical(s) in-situ, minimizing or negating the need to provide supplemental means to mix the chemical in the water to be treated.

In another aspect, the electrochemical cell, module or reactor is used to generate chemical species that have utility in the treatment of water, after which the generated chemical species are applied to the treatment of water.

In this aspect, the electrochemical cell, module or reactor is preferably but not exclusively, present and used on or at the same site as the site at which the water is treated i.e. on-site.

Preferably, but not exclusively, the electrochemical cell, module or reactor comprises a multi-electrode array of manufactured abiological materials, which can be densely packed or stacked. In one example the multi-electrode array is wholly made of manufactured abiological materials, or only made from manufactured abiological materials. Preferably, the electrochemical cell is an electro-synthetic cell (i.e. a commercial cell having industrial application). In another example, the cell utilizes abiological manufactured components. In another example, there is provided an inter-electrode channel between the anode and the cathode for gas and/or fluid transport. Optionally, there is provided two anodes and an anode channel between the two anodes for gas and/or fluid transport. Also optionally, there is provided two cathodes and a cathode channel between the two cathodes for gas and/or fluid transport. In another example, the channel is at least partially formed by at least, one spacer, for example a porous polymeric material, sheet or membrane. In another example, there is provided at least two anodes and at least one anode channel and at least two cathodes and at least one cathode channel.

In one example aspect, there is provided a spiral-wound electrochemical cell, module or reactor having a core element, around which one or more electrodes (e.g. least one electrode pair provided by an anode or a cathode) are wound in a spiral fashion. The at least one electrode pair can form part of a multi-electrode array, which can be considered as being comprised of a series of flat flexible anodes and cathodes that can be wound in a spiral fashion.

Various designs, structures and electrodes can be used that have particular utility as efficient, “on-site” or “in-situ” electrochemical cells, modules or reactors for water treatment. These include cells, modules or reactors having “flat-sheet”, “spiral-wound” or “hollow-fibre” arrangements of multi-electrodes or multi electrode arrays. International Patent Application No. PCT/AU2013/000617 for “Gas Permeable Electrodes and Electrochemical Cells” filed 11 Jun. 2013, is incorporated herein by reference, and describes gas diffusion electrodes, and aspects thereof, that can be spiral-wound and utilised in the present examples.

Further aspects and details of example cells, modules, structures and electrodes that can be utilised in the present examples are described in the Applicant's previously filed International Patent Application No. PCT/AU2014/050161 for “Modular Electrochemical Cells” filed 30 Jul. 2014, the Applicant's previously filed International Patent Application No. PCT/AU2014/050160 for “Composite Three-Dimensional Electrodes and Methods of Fabrication” filed 30 Jul. 2014. the Applicant's previously filed International Patent Application No. PCT/AU2014/050162 for “Electro-Synthetic or Electro-Energy Cell With Gas Diffusion Electrode(s)” filed on 30 Jul. 2014, and the Applicant's previously filed International Patent Application No. PCT/AU2014/050158 for “Method and Electrochemical Cell for Managing Electrochemical Reactions” filed on 30 Jul. 2014, which are all incorporated herein by reference.

Still further aspects of example electrochemical cells and structures are described in the Applicant's concurrently filed International Patent Application for “Electrochemical Cells and Components Thereof” filed on 10 Dec. 2014, which is incorporated herein by reference.

In an example embodiment, a spiral-wound electrochemical cell containing at least one gas diffusion electrode, that is spiral-wound, preferably at least one of the aforementioned gas diffusion electrodes, is used to generate one or more disinfection agents as the one or more chemicals. The disinfection agents are then, preferably, applied to treat water on or at the same site as that at which water treatment is required. For example, wastewater containing unwanted bio-materials may be disinfected by the application of one or more disinfection agents generated by an “on-site” and/or an “in-situ” spiral-wound electrochemical cell utilising gas diffusion electrodes, preferably of the cross-referenced type. By way of example only, the disinfection agents may include but are not limited to chlorine—hypochlorite, so-called mixed oxidants, and/or hydrogen peroxide.

In another aspect there is provided an electrochemical cell, module or reactor of wholly manufactured abiological materials or origin for the direct treatment of water. In this aspect, water is treated by being passed through, or circulated within the electrochemical cell, module or reactor.

In example embodiments of this aspect, the electrochemical cell, module or reactor comprises a densely-packed multi-electrode array that has a design having utility as efficient, “on-site” electrochemical cells, modules or reactors. Preferably but not exclusively, the electrochemical cell, module or reactor comprises a “flat-sheet”, “spiral-wound” or “hollow-fibre” multi-electrode army of the aforementioned type.

Preferably, but not exclusively, one or more, or each, electrode in such a multi-electrode array is permeable to a gas, or gases, but impermeable to the water being treated. Preferably but not exclusively, each electrode in such a multi-electrode array comprises a gas diffusion electrode of the aforementioned type.

Preferably, but not exclusively, each electrode in such a multi-electrode array has associated with it, distinct gas channels along which one or more gases may permeate through the gas diffusion electrodes into or out of the water stream, preferably immediately adjacent to, or at the electrode surface.

Preferably, but not exclusively, reactant gases are brought into the cell, module or reactor, via the gas channels and introduced into the water stream through the one or more as diffusion electrodes during the water treatment process. For example, the cell, module or reactor may harness atmospheric or pure oxygen as a reactant gas, introduced into the water stream via the electrode gas channels and gas diffusion electrodes, to electrochemically treat the water.

Preferably, but not exclusively, the electrochemical cell, module or reactor acts to transform unwanted entities in the water, into harmless and/or easily removed species such as, but not limited to gaseous species. For example, the cell, module or reactor may facilitate the electrochemical transformation at the gas diffusion electrodes, e.g. gas-permeable electrodes, of water-borne chemical species like nitrates, ammonia, and the like, into gaseous products. Thus, a reactant gas can be brought into the cell via the gas channel and introduced into a water stream through the one or more gas diffusion electrodes during water treatment. The gaseous products preferably, but not exclusively, exit the water stream through the one or more gas diffusion electrodes and their associated gas channels, to thereby leave the electrochemical cell, module or reactor.

In a further aspect there is provided an electrochemical cell, module or reactor including at least one a cathode that in operation may produce a cathode product, and/or at least one anode that in operation may produce an anode product, where one or both of the anode product and/or cathode product provides a treatment action upon water passing through the cell, module or reactor. For example, one or both of the anode product or cathode product may involve a disinfectant chemistry that cleans the water, including, but not limited, to the production of chlorine—hypochlorite, hydrogen peroxide, and/or other chemistries that destroy microorganisms. The cell may be manufactured from abiological materials.

An example embodiment involves an electrochemical cell for generating hydrogen gas and oxygen gas in-situ and using at least one of the produced gases for water treatment. The generated hydrogen gas can be used as an agent for catalytically reducing unwanted species such as arsenate, perchlorate, nitrate, or other agents and the hydrogen gas can also be used to feed bacteria (including autotrophic bacteria) that reduce unwanted species such as arsenate, perchlorate, nitrate, or other agents. The generated oxygen gas can be used to in-situ aerate bacteria that lower the biological oxygen demand (BOD) of wastewater.

In another aspect there is provided an electrochemical cell, module or reactor, comprising a cathode that in operation may consume a cathode reactant, and/or an anode that in operation may consume an anode reactant, where the consumption of one or both of the anode and/or cathode reactants provides a treatment action upon water passing through the cell, module or reactor. For example, one or both of the anode or cathode reactants may involve an unwanted species within the water, whose removal forms the basis of the water treatment process.

### BRIEF DESCRIPTION OF THE DRAWINGS

Illustrative embodiments will now be described solely by way of non-limiting examples and with reference to the accompanying figures. Various example embodiments will be apparent from the following description, given by way of example only, of at least one preferred but non-limiting embodiment, described in connection with the accompanying figures.

FIG. 1 illustrates an example cell and process for on-site generation of chlorine.

FIG. 2(a) schematically illustrates an example flat-sheet electrochemical cell for the generation of chlorine—hypochlorite useful in disinfecting waste water. FIGS. 2(b) and 2(c) illustrate spiral-wound versions of the cell.

FIG. 3 depicts in schematic format, an example “flow-through” cell for the treatment of water with hydrogen peroxide disinfectant.

### EXAMPLES

The following modes, features or aspects, given by way of example only, are described in order to provide a more precise understanding of the subject matter of a preferred embodiment or embodiments.

International Patent Application No. PCT/AU2013/000617 for “Gas Permeable Electrodes and Electrochemical Cells” filed 11 Jun. 2013is incorporated herein by reference and describes gas diffusion electrodes, and aspects thereof, that can he spiral-wound and utilised in the present examples.

Further aspects and details of example cells, modules, structures and electrodes that can be utilised in the present examples are described in the Applicant's previously filed International Patent Application No. PCT/AU2014/050161 for “Modular Electrochemical Cells” filed 30 Jul. 2014, the Applicant's previously filed International Patent Application No. PCT/AU2014/050160 for “Composite Three-Dimensional Electrodes and Methods of Fabrication” filed 30 Jul. 2014, the Applicants previously filed International Patent Application No. PCT/AU2014/050162 for “Electro-Synthetic or Electro-Energy Cell With Gas Diffusion Electrode(s)” filed on 30 Jul. 2014, and the Applicant's previously filed International Patent Application No. PCT/AU2014/050158 for “Method and Electrochemical Cell for Managing Electrochemical Reactions” filed on 30 Jul. 2014, which are all incorporated herein by reference.

The electrodes described in the above patent applications, and “conventional” was diffusion electrodes as they are described in the above patent applications, may be used in the electrochemical cells of the present invention.

Still further aspects of example electrochemical cells and structures are described in the Applicant's concurrently filed. International Patent Application for “Electrochemical Cells and Components Thereof” filed on 10 Dec. 2014, which is incorporated herein by reference.

In one embodiment, the electrochemical cell is provided in a “flat-sheet” or “spiral-wound” format. The “flat-sheet” and “spiral-wound” cells, modules or reactors typically involve flexible, gas-permeable, liquid-impermeable gas diffusion electrode sheets or layers stacked in two or more layers, where the electrodes are separated from one another by spacers or spacer layers, for example distinct electrolyte channel spacers (which are permeable to, and intended to guide the permeation of liquid electrolyte through the cell) and/or gas channel spacers (which are permeable to, and intended to guide the permeation of gases through the cell). There may be more than one type of gas channel. For example, there may be two distinct as channels, one for a first gas (e.g. hydrogen in a water electrolysis cell) and another for a second gas (e.g. oxygen in a water electrolysis cell). There may, similarly, be separate channels for more than one electrolyte. For example, in a modified chlor-alkali cell suitable for manufacturing chlorine—hypochlorite disinfection chemistries, there may be separate channels for the feed electrolyte (NaCl solution, 25%, pH 2-4) and the product electrolyte.

In the “spiral-wound” arrangement, the resulting multi-electrode stack is tightly wound about a core element, to thereby create the spiral-wound cell or module. The core element may contain some or all of the gas-liquid and electrical conduits with which to plumb and/or electrically connect the various components of the cell or module. For example, the core element may combine all of the channels for one or another particular gas in the slack into a single pipe, which is then conveniently valved for attachment to an external gas tank. The core element may similarly contain an electrical arrangement which connects the anodes and cathodes of the module into only two external electrical connections on the module—a positive pole and a negative pole,

One key advantage of spiral-wound cells or modules over other module arrangements is considered to he that they provide a high overall electrochemical surface area within a relatively small overall geometric footprint. A spiral-wound electrochemical module is believed to provide for the highest possible active surface area within the smallest reasonable footprint.

Another advantage of spiral-wound arrangements is that round objects are easier to pressurize than other geometries which involve corners. So, the spiral design has been found to be beneficial for electrochemical cells in which the electrochemical reaction is favourably impacted by the application of a high pressure.

In another embodiment, there is provided a “hollow-fibre” electrochemical reactor, comprising a plurality of hollow fibre electrodes (as either or both of a cathode or an anode) and a plurality of other electrodes (as the opposite electrode). A plurality of hollow fibre cathodes comprise a hollow fibre gas permeable, but liquid-impermeable material having a conductive layer, that may include a catalyst. A plurality of hollow fibre anodes comprise a hollow fibre as permeable membrane having a conductive layer that may include a catalyst.

Regardless of whether the reactor or cell arrangement is spiral wound, flat sheet or hollow fibre, the modular reactor units may be so engineered as to be readily attached to other identical modular units, to thereby seamlessly enlarge the overall reactor to the extent required.

The combined modular units may themselves be housed within a second, robust housing that contains within it all of the liquid that is passed through the modular units and which serves as a second containment, chamber for the gases that are present within the interconnected modules.

The individual modular units within the second, outer robust housing may be readily and easily removed and exchanged for other, identical modules, allowing easy replacement of defective or poorly operational modules.

### Example 1

### An “On-site” Spiral-wound Electrochemical Reactor to Generate Chlorine-based Disinfection Agents for Water Treatment

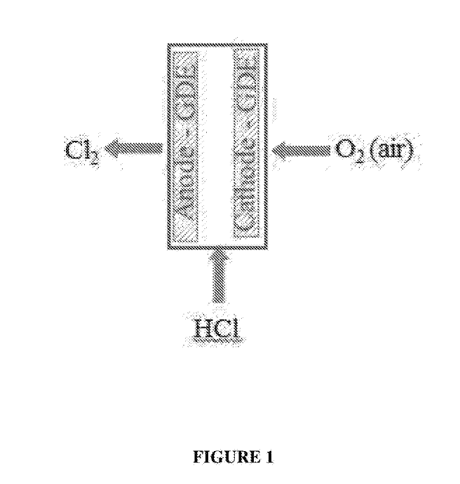

FIG. 1 schematically depicts the key components of a cell in which the chlor-alkali process may be adapted for the production of chlorine, without caustic, in a highly energy-efficient and cost-efficient manner, that is amenable to small-scale, on-site, modular production. The cell uses gas diffusion electrodes (GDEs) of the aforementioned type, and the examples that are incorporated herein by reference.

The cell utilizes hydrochloric acid (HCl) or acidified table salt (NaCl) as the reactant. If the cell utilizes NaCl, then it must generally be used in a “flow-through” cell configuration (which is described in greater detail in Example 2). Upon the application of a suitable voltage, chlorine gas is generated in a bubble-fee manner, at the cathode, which employs an example GDE. The depolarising gas, oxygen may be introduced via a GDE at the cathode. Note the absence of an expensive and energy-sapping diaphragm between the electrodes.

The half-reactions that occur are as follows:

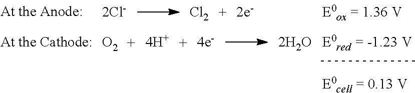

As can be seen, the cell voltage is a mere 0.13 V, which is very substantially less than a conventional chlor-alkali process, which has a cell voltage of 2.19 V. Thus, such a cell is far cheaper to operate and more energy efficient than a cell of the conventional chlor-alkali process.

Moreover, this design eliminates many of the costs and complexities of conventional chlor-alkali cells and is conducive to being used in a small-scale, modular unit for on-site production of chlorine at the point at which the chlorine is required by the user.

Of critical importance is the fact that such a cell generates no caustic (which is a normal by-product of the chlor-alkali process); chlorine is the only product. As such, the above process is more practical than the conventional chlor-alkali process for users who want and need only chlorine and have no use for caustic.

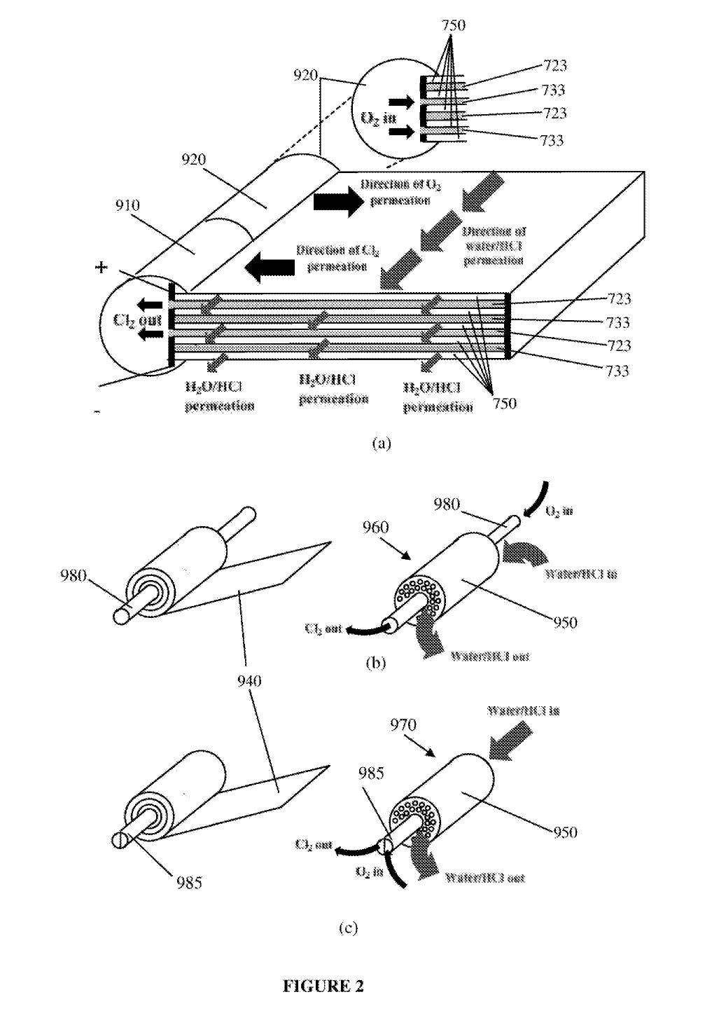

FIG. 2(a) schematically depicts a flat-sheet module of the type described in International Patent Application No. PCT/AU2013/000617 for “Gas Permeable Electrodes and Electrochemical Cells” filed 11 Jun. 2013, which is incorporated herein by reference. The module has been adapted to employ the above half-reactions to generate chlorine.

The module comprises alternating, double-sided sheet anodes 723 (incorporating a central gas channel for chlorine) and sheet cathodes 733 (incorporating a central gas channel for oxygen), separated by water-permeable spacers 750. The anodes and cathodes are gas diffusion electrodes (GDEs) of the aforementioned or cross-referenced type. They comprise two un-supported ePTFE membranes (pore site 0.2 μm), for example available from General Electric Corporation, with, between them, a gas-channel spacer (for example a PVDF polymer net). The double-sided sheet anodes and cathodes have each been vacuum-coated with a conductive platinum layer. The water-permeable spacers are PVDF polymer nets, which are sold as “feed-channel” spacers for the reverse-osmosis industry by the company Delstar Inc.

On the left of the flat-sheet assembly is a PTFE bifurcated tube, which contains a rear chamber 920 connected to the gas channels within the cathodes 733 (for introduction of oxygen (O₂) into the cathode). A forward chamber 910 is connected to the as channels within the anodes 723 (for collection of the chlorine that is produced).

The directions in which the gases and liquids permeate within the module are shown in FIG. 2(a). Upon application of a suitable cell voltage (e.g. 1.8 V) across the positive (+) and negative (−) poles shown in FIG. 2(a) and the introduction of oxygen gas (either pure or atmospheric) into the cathode as shown, chlorine gas is generated at the anodes 733 and collected in the bifurcated tube 910 on the left of the module, as shown.

As depicted in FIGS. 2(b) and 2(c) the flat-sheet assembly in FIG. 2(a) may be wound up into a spiral-wound arrangement 940, which is shown partially wound, and which when fully wound may then be enclosed in a polymer case 950. The electrochemical cells 960, 970 can be considered as an electro-synthetic (i.e. a commercial cell having industrial application). FIG. 2(b) shows cell 960 receiving oxygen gas into one end of core element 980 and chlorine gas being produced out of the other end of the core element 980. Water and HCl flow axially through cell 960, entering at one distal end and exiting at the other distal end. FIG. 2(c) shows another example cell 970 receiving oxygen gas into one end of different core element 985 and chlorine gas being produced out of the same end of the core element 985. Water and HCl flow axially through cell 970, entering at one distal end and exiting at the other distal end. In this example, core element 985 need not extend from both ends of cell 970.

Preferably, the cell utilizes abiological manufactured components, such as polymer materials, metallic materials, etc., and can wholly use manufactured abiological components. In one example, there can be provided an inter-electrode channel between the anode and the cathode for gas and/or fluid transport. Optionally, in other forms, there can be provided two anodes and an anode channel between, the two anodes for gas and/or fluid transport. Also optionally, there can be provided two cathodes and a cathode channel between the two cathodes for gas and/or fluid transport. In another example, the channel is at least partially formed by at least one spacer, for example a porous polymeric material, sheet or membrane, whose porosity can be selected to selectively allow gas and/or fluid transport through the spacer. In another example, there is provided at least two anodes and at least one anode channel, and at least two cathodes and at least one cathode channel.

In another example, a spiral-wound electrochemical cell or module has a central longitudinal axis along the spiral-wound cell or module. A core element 980, 985 which can include gas channels, and/or possibly water channels, and/or electrical connections to the electrodes, such as a busbar(s), can be provided at or around the central longitudinal axis. Around the core element one or more electrodes (e.g. at least one electrode pair provided by an anode or a cathode) can be wound in as spiral fashion. The at least one electrode pair can form part of a multi-electrode array, which can be considered as being comprised of a series of flat flexible anodes and cathodes that can be wound in a spiral fashion.

In other examples, at least one of the one or more gas diffusion electrodes is flexible and comprises a gas permeable material that is non-conductive, and a porous conductive material attached to the gas permeable material. Preferably, the gas permeable material is impermeable to water, and the porous conductive material is permeable to water. The porous conductive material is preferably provided adjacent to the gas permeable material. In another example, the one or more gas diffusion electrodes include at least one electrode pair of a cathode and an anode wound about a central longitudinal axis of the spiral-wound cell. In other variations, he anode is gas permeable and water impermeable; and/or the cathode is gas permeable and water impermeable.

The chlorine generated by a cell of this type may be useful in water treatment. Chlorine kills microorganisms by oxidizing free sulfhydryl groups, disruption of cell membrane and wall components, and degradation of a variety of cellular macromolecules. When dissolved in water, chlorine (Cl₂) engages in a chemical equilibrium with HOCl (hypochlorous acid) and OCl⁻ (hypochlorite anion), both of which are also powerful antimicrobial agents. At pH 4-7, all the chlorine is, effectively, present as HOCl which is two orders of magnitude more effective than OCl⁻ as a disinfectant. Maximum disinfecting efficacy is achieved at pH 4-5, because essentially all the chlorine is present as HOCl. However, for safety and efficacy, a pH of 5-7 works best.

The direct, on-site generation of chlorine using such a cell is overall a more efficient method of water disinfection than typical current chemical processes.

At the present time, many water treatment processes employ sodium hypochlorite (NaClO) as a disinfectant. Sodium hypochlorite, which forms the OCl⁻ (hypochlorite) anion in solution, is manufactured using the Hooker process, where chlorine is passed into cold and dilute sodium hydroxide solution according to the equation:

Cl₂+2 NaOH NaCl+NaClO+H₂O

In so doing, only one of the two chlorine atoms in the Cl₂ is utilized; the other forms NaCl, which must be re-cycled to regenerate Cl₂. Thermochemical recycling is very energy intensive. Moreover, the sodium hypochlorite must then be transported to the site of water treatment.

It should also be noted that the Cl₂ used in this process is typically generated in large-scale chlor-alkai plants, which are themselves highly energy and atom inefficient as this process requires a large overpotential (E_{cell}=2.19 V) and co-generates waste hydrogen gas, which must typically be flared off.

By comparison, an on-site, direct chlorine generator of the above type avoids all of these intermediate steps and associated inefficiencies. It also generates an extremely powerful disinfectant agent. Moreover, because of the simplicity of the cell and the cell's low energy consumption, it is possible to deploy this process in a small-scale, on-site process for water treatment facilities that only need relatively small amounts of chlorine. The hydrochloric acid feedstock is often inexpensively available as a waste product from other industrial processes (it often forms the second, unused Cl atom in industrial processes that use Cl₂).

Such an on-site, spiral-wound water treatment generator may be conveniently used to disinfect wastewater contaminated with large amounts of biomaterials.

### Example 1a

### An “On-site” Spiral-wound Electrochemical Reactor to Generate Hydrogen Gas for Removing Nitrates, Ammonia, and other Unwanted Species from Water

Hydrogen gas generated by the cell can be used as an agent for catalytically reducing unwanted species such as nitrate, ammonia, arsenate, perchlorate, or other agents. The hydrogen gas can also be used to feed bacteria (including autotrophic bacteria) that reduce unwanted species such as arsenate, perchlorate, nitrate, or other agents. The generated oxygen gas can be used to in-situ aerate bacteria that lower the biological oxygen demand (BOD) of wastewater.

### Example 2

### Direct Treatment of a Wastewater Stream with a “Flow-through” Electrochemical Cell

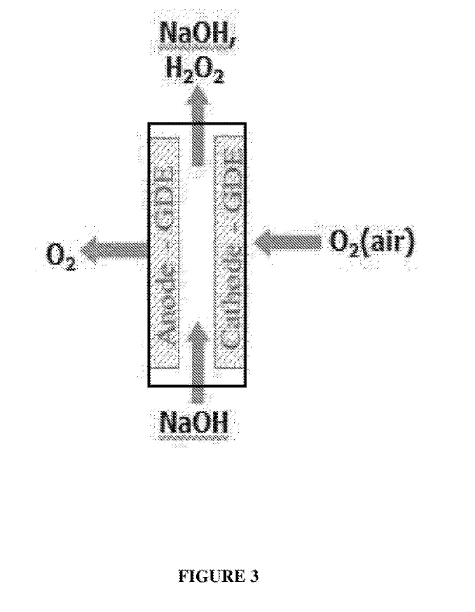

In alkaline water streams, hydrogen peroxide may be manufactured electrochemically. The process preferably uses two gas-diffusion electrodes of the aforementioned types. FIG. 3 schematically depicts the cell configuration. Oxygen is typically fed into the gas-diffusion cathode, thereby inducing the following half reactions when a suitable voltage and current are applied:

Cathode: 2O₂+2H₂O+4 e⁻+2OH⁻ (1)

Anode: 4 OH⁻→O₂+2 H₂O+4 e⁻ (2)

OVERALL: O₂+2 OH⁻→2 HO₂⁻E^{o}_{cell}0.476 V (3)

As can be seen, the overall cell voltage is very low, being only 0.476 V. The reaction further consumes unwanted base, OH⁻, and atmospheric oxygen. O₂, to make the hydroperoxide ion, HO₂⁻, which is the natural state of hydrogen peroxide under basic conditions. Catalysts capable of facilitating hydroperoxide formation are required.

A spiral-wound cell of similar design to that described in the previous example may be used, with the pure oxygen produced at the anode recycled back to the cathode. In such a cell, the water to be treated must be passed through the cell as the feedstock, in the same way that hydrochloric acid was in the previous example.

The water would thereby be electrochemically treated with hydrogen peroxide, H₂O₂, which is a powerful disinfectant. Furthermore, mixed oxidants, such as chlorine and hydrogen peroxide, may be simultaneously generated for water treatment.

The inventors have successfully constructed cells of this type using an example GDE of the aforementioned kind. The GDE substrate was a PTFE membrane (0.2 micron pore size, from General Electric Corporation) of the type used for membrane based distillation in the water purification industry. For both of the anode and cathode, the membrane was either: (i) coated with a thin layer of nickel (by carefully calibrated vacuum deposition of nickel, to lay down 3.64 g of nickel per 1 square metre of geometric area), or (ii) a 200 LPI nickel mesh and a binder were laminated to the membrane as described in a previous example.

The inventors have further constructed a cell using a “conventional” GDE of the type described in the cross-referenced patent applications. In this case, the electrode comprised of a compressed mixture of PTFE (50% by weight and carbon black (50% by weight), containing Pt catalyst (0.2 g/m²).

In an alternative embodiment that is described in Example 1, acidified table salt is added to the water. Upon the application of a suitable voltage, chlorine gas is generated as a disinfectant at the anode. In such a cell, the water to be treated is continuously passed through the cell as the feedstock.

It is to be understood that this example embodiment is not intended to be limiting and other configurations of electrochemical cells may fall within the spirit, and scope of this application. For example, spiral-wound cells of the above type may also be used to directly remove chemical contaminants, such as urea or ammonia, using catalysts known to the art.

Throughout this specification and the claims which follow, unless the context requires otherwise, the word “comprise”, and variations such as “comprises” or “comprising”, will be understood to imply the inclusion of a stated integer or step or group of integers or steps but not the exclusion of any other integer or step or group of integers or steps.

Optional embodiments may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

Although a preferred embodiment has been described in detail, it should be understood that many modifications, changes, substitutions or alterations will be apparent to those skilled in the art without departing from the scope of the present invention.

1. A spiral-wound electrochemical cell for the treatment of water, comprising abiological components and one or more gas diffusion electrodes that are spiral-wound, and the electrochemical cell able to generate, on-site or in-situ, one or more chemicals for the treatment of water.

2. The cell of claim 1, wherein the one or more chemicals are one or more disinfection agents.

3. The cell of claim 2, wherein the one or more disinfection agents include chlorine-hypochlorite, mixed oxidants, and/or hydrogen peroxide.

4. The cell of claim 1, wherein water is directly treated by being passed through, or circulated within, the cell.

5. The cell of claim 1, wherein the one or more gas diffusion electrodes are permeable to a gas but impermeable to water.

6. The cell of claim 1, wherein a gas channel is provided along which one or more gases may permeate through the one or more gas diffusion electrodes.

7. The cell of claim 6, wherein a reactant gas is brought into the cell via the gas channel and introduced into a water stream through the one or more gas diffusion electrodes during water treatment.

8. The cell of claim 1, wherein a water-borne chemical species in a water stream undergoes an electrochemical transformation at the one or more gas diffusion electrodes into a gaseous product.

9. The cell of claim 8, wherein the gaseous product exits the water stream through the one or more gas diffusion electrodes.

10. The cell of claim 1, wherein the one or more gas diffusion electrodes includes at least one cathode that in operation produces a cathode product, wherein the cathode product provides a treatment action upon water passing through the cell.

11. The cell of claim 1, wherein the one or more gas diffusion electrodes includes at least one anode that in operation produces an anode product, wherein the anode product provides a treatment action upon water passing through the cell.

12. The cell of claim 1, wherein the one or more chemicals is or includes hydrogen gas and the generated hydrogen gas is used as an agent for catalytically reducing an unwanted species.

13. The cell of claim 1, wherein the one or more chemicals is or includes oxygen gas and the generated oxygen gas is used as an agent to aerate bacteria that lower the biological oxygen demand (BOD) of wastewater.

14. The cell of claim 1, wherein at least one of the one or more gas diffusion electrodes is flexible and comprises:
a gas permeable material that is non-conductive; and
a porous conductive material attached to the gas permeable material.

15. The cell of claim 14, wherein the gas permeable material is impermeable to water, and the porous conductive material is permeable to water.

16. The cell of claim 15, wherein the porous conductive material is provided adjacent to the gas permeable material.

17. The cell of claim 1, wherein the one or more gas diffusion electrodes includes at least one electrode pair of a cathode and an anode wound about a central longitudinal axis of the spiral-wound cell.

18. The cell of claim 17, wherein:
the anode is gas permeable and water impermeable; and/or
the cathode is gas permeable and water impermeable.
